(19) United States
(12) Patent Application Publication
(10) Pub. No.: US 2024/0160708 A1
(43) Pub. Date: May 16, 2024

(54) SYSTEM AND METHOD FOR DETECTING AND PREVENTING AN IDENTITY THEFT ATTEMPT

(71) Applicant: Capital One Services, LLC, McLean, VA (US)

(72) Inventors: Dwij TRIVEDI, Oakton, VA (US); Abhay DONTHI, Arlington, VA (US); Salik SHAH, Washington, DC (US); Jennifer KWOK, Brooklyn, NY (US); Leeyat Bracha TESSLER, Arlington, VA (US)

(73) Assignee: Capital One Services, LLC, McLean, VA (US)

(21) Appl. No.: 17/984,499

(22) Filed: Nov. 10, 2022

(51) Int. Cl. G06F 21/32

(52) U.S. Cl. CPC G06F 21/32

(57) ABSTRACT

A system and method for detecting and prevent identity theft attempts, such as phishing, vishing or other similar attacks is disclosed. A smart device, such as a smartphone operates in tandem with a biometric sensor, such as is included in a wearable device like a smartwatch or fitness tracker. The wearable tracks certain biometric and/or physiological data that can be used to identify whether the user is in a stressed state. The smart device then accesses usage logs that may indicate whether the stressed state is justified, such as whether the user had a calendar appointment at that time, or whether the call was received from a known contact etc. Justifications reduce the likelihood that the user's stress is a result of an identity theft attempt, whereas lack of justification increases the likelihood. In the latter scenario, the user is notified not to divulge sensitive information.

### TECHNICAL FIELD

Embodiments of the present disclosure are related to detecting and preventing an identity theft attempt, and specifically to detecting a phishing or equivalent attack based on user stress levels and phone usage data.

### BACKGROUND

In modern times, bad actors have significantly ramped up efforts to obtain social security numbers and other sensitive personal information from individuals through nefarious means, such as phishing, vishing, or other similar attacks. Specifically, in these types of attacks, the bad actor contacts an individual over phone, email, voicemail, or other similar mechanisms, and pretends to be from a reputable company. The bad actor then usually warns the individual of some problem with their account, and requests that the individual “verify” their account or personal information in order to cure the problem. The individual unknowingly provides their account or personal information, and then the bad actor improperly gains access to their financial account information.

### BRIEF DESCRIPTION OF THE DRAWINGS/FIGURES

The accompanying drawings are incorporated herein and form a part of the specification.

FIG. 1 illustrates an exemplary identity theft detection environment according to various embodiments.

FIG. 2 illustrates a block diagram of an exemplary identity theft prevention system according to various embodiments.

FIG. 3 illustrates a block diagram of an exemplary identity theft prevention system according to various embodiments.

FIG. 4 illustrates a flowchart diagram of an exemplary method for preventing identity theft according to various embodiments.

FIG. 5 illustrates a flowchart diagram of an exemplary method for preventing identity theft according to various embodiments.

FIG. 6 illustrates a flowchart diagram of an exemplary method for preventing identity theft according to various embodiments.

FIG. 7 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for detecting and preventing identity theft attempts.

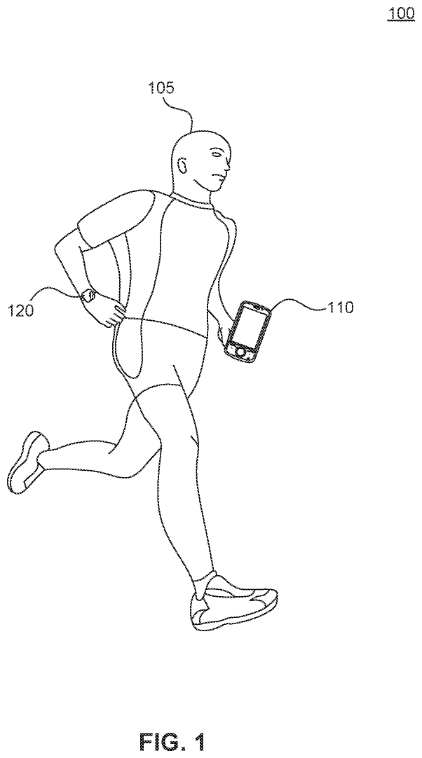

FIG. 1 illustrates an exemplary identity theft detection environment 100 according to various embodiments. As shown in FIG. 1, a user 105 is in possession of a smart device 110, such as a smart phone, tablet device, or other similar device. The user 105 is also wearing a wearable device 120, such as a fitness tracker or smart watch that is capable of detecting certain biometrics and other physiological information of the user 105.

According to embodiments, the wearable device 120 is configured to track certain biometric and/or physiological data associated with the user, such as step cadence, heartrate, blood pressure, and electrodermal activity (EDA). In an embodiment, the wearable device 120 uses this information to calculate a stress indicator. Specifically, the wearable device 120 analyzes the biometric and physiological data, and differentiates elevated data between one or more different workouts or a high stress level. In other words, the wearable device may identify certain stress indicators as being an elevated heartrate, elevated oxygen saturation (SpO₂), or higher than normal blood pressure. For example, if the user has a high heartrate and/or high blood pressure, but does not appear to be working out, this may indicate a high stress level. In another example, a particular nervous system measurement or EDA measurement that is higher than normal or over a given threshold may indicate that the user has a high stress level. If a high stress level is identified, then this result is provided to the smart device 110.

Alternatively, the wearable device 120 collects the biometric and physiological data and provides this data directly to the smart device 110 for analysis. The smart device 110 receives the biometric and physiological data. From this information, the smart device 110 calculates whether the user is in a stressed state. For example, when a predetermined number of stress indicators are present in the data received from the wearable device, the smart device 110 attempts to determine whether the user's stress is justified (e.g., the result of physical activity or of a known event having high stress probability), or whether the user's stress level is not supported by a known justification. In order to make this determination, the smart device 110 also accesses other information available on the smart device 110, such as the user's calendar, call logs, contact list, etc. The smart device 110 uses this additional information to conduct a thorough analysis of the user's physiological state, and whether the identification of a stressful user state is justified. Specifically, there may be several ways to justify a stressful state. For example, if the stressful state occurred the same time as a phone call from a known contact (based on a comparison of the call log time and number to the contact list), then the stressful state is likely justified. Similarly, the stressful state may also be justified if it coincides with a meeting on the user's calendar.

The inverse is also true—an elevated stress level that coincides from a phone call from an unknown number raises the likelihood of a phishing/vishing attack. These events can be examined individually or collectively by the smart device 110 in order to determine whether the elevated stress is justified or a result of a likely identity theft attempt. Remedial action can then be taken. For example, the cause of the stress may be determined by a machine learning algorithm that has been trained on stress levels associated with fraudulent communications, such as phishing or vishing, and legitimate communications.

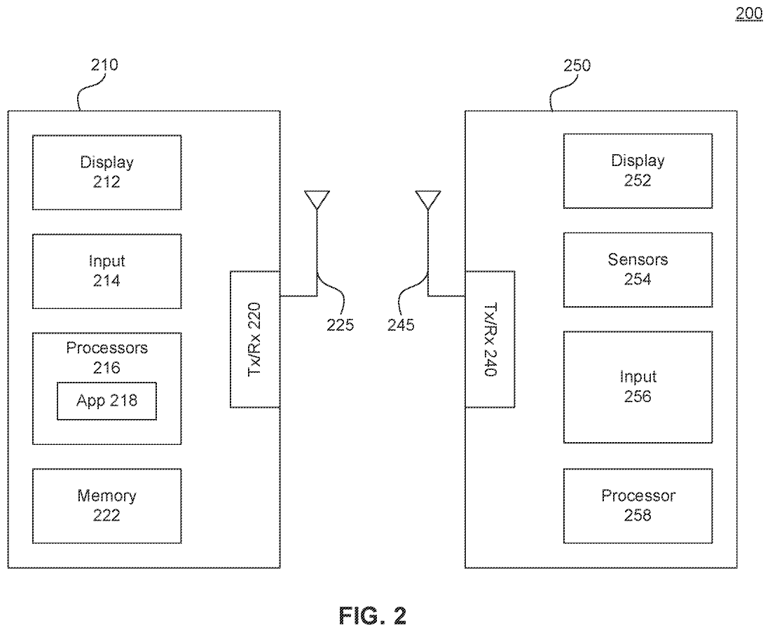

FIG. 2 illustrates a block diagram of an exemplary identity theft prevention system 200 according to various embodiments. As shown in FIG. 2, a smart device 210 includes a display 212, input 214, processors 216, transceiver 220, and memory 222. One or more antennas 225 can be connected to the transceiver 220. Additionally, the processors 216, which can be one or more processors and/or circuits, can execute one or more applications (“apps”), such as app 218. App 218 can include software code that, when executed by the one or more processors and/or circuits, causes the one or more processors and/or circuits to perform certain functions. The software code executable by the one or more processors and/or circuits may be stored, for example, on memory 222. A person of ordinary skill in the art will understand that when certain functions are described as being performed by app 218, this means that the functions identified in the executable code of the app are being executed by the one or more processors and/or circuits. App 218 carries out the stress calculations, the identity theft attempt determinations, and the notifications as described herein. Memory 222 stores usage information, such as the user's calendar of events, contact list, call logs, text history, as well as any other usage data of the user. In some embodiments, acts performed by the app or by the smart device may be performed, at least in part, by another system such as a server or cloud computing infrastructure.

The system 200 also includes wearable device 250. The wearable device 250 includes an optional display 252, one or more sensors 254, input 256, one or more processors 258, and a transceiver 240. One or more antennas 245 can be connected to the transceiver for wireless communication.

In operation, the one or more sensors 254 of the wearable device 250 collects biometric and/or physiological data associated with the user. This data can include heartrate, blood pressure, step cadence/intensity, EDA, SpO₂, etc. In an embodiment, this data is provided to the one or more processors 258, which analyzes the data to make a determination as to whether the user is in a stressed state. In an embodiment, this information is provided to an algorithm executed by the processors 258 that seeks to categorize the physiological information as being one of an at-rest state, an exercise state, or a stressed state. In another embodiment, the biometric and/or physiological data is provided in raw form to the smart device 210, which runs the stress detection algorithm within processors 216.

The smart device 210 uses the information from the wearable device 250 to determine whether the user is in a stressed state based on the physiological data. In an embodiment, this determination is made by comparing each of the physiological data points to corresponding thresholds, and determining whether more than a predetermined number of those data points exceed their respective levels (e.g., indicate stress). The one or more processors 216 also obtains usage data from the memory 222. This information is provided to an algorithm, such as a trained machine learning algorithm, run by app 218 that predicts whether the user is experiencing an identity theft attack. Specifically the usage data can be analyzed by the algorithm to determine whether the user's stressed state is justified. According to embodiments, determining that the user was performing a known activity during a high-stress period mitigates or “justifies” that stressful period, resulting in a negative determination that an attack is taking place. For example, an analysis of the calendar may indicate that the user's stressed state coincides with a meeting, or an analysis of the call log may indicate that the user's stressed state coincides with a call from a known contact. Likewise, determining that there is no known justification for a high-stress period, or an activity that suggests a potential attack (e.g., such as a phone call from a phone number not listed in the user's contacts) may result in a positive determination that an attack is occurring.

Factors that may be analyzed and used to either increase or decrease the likelihood that user stress relates to an identity theft attempt can include whether a call was initiated or received, whether the contact was known or unknown, whether the stressed state coincided with a meeting, etc. In some embodiments, the algorithm can be configured to consider more personal information, such as the content of communications. For example, in an embodiment, the memory 222 further stores voice data of telephone communications and emails, text messages, and other text-based messages. In an embodiment, the processors 216 are further configured to perform speech recognition on the voice communications and store the text of the speech conversation in the memory 222.

During analysis, the one or more processors 216 can review the various communications that occurred at or around the time of the user's stress for keywords, key phrases, key topics, etc. in order to further enhance the determination as to whether the user's stress is justified. In this embodiment, keywords related to urgency and/or financial accounts or transactions, such as “account,” “immediately,” “problem,” etc. may indicate a likely identity theft attack, whereas a lack of these keywords or keyword types, and/or other the presence of other keywords or keyword types that may indicate an unrelated stress, reduce the likelihood of an identity theft attack. Notably, reviews of the contents of the user's communications will typically require user permission and/or enrollment.

After the algorithm running in the app 218 analyzes the available data, it will output a determination as to whether the user is likely experiencing an identity theft attack. If the output indicates no attack, then no further action is taken with respect to the user's current state. Meanwhile, the smart device 210 and the wearable device 250 continue to exchange information and cooperate in order to identify future attacks.

However, if the app 218 indicates that there is a likelihood of the user experiencing an identity theft attack, then remedial action is taken. For example, in embodiments, the processors 216 cause the display to display a message to the user warning them of the likely identity theft attack and reminding them to be careful divulging sensitive information. Additionally, the processors 216 may cause the smart device 210 to issue audible and/or other feedback to the user as a warning, such as beeping, vibrating, etc. By warning the user in this manner, a potential identity theft attack can be averted.

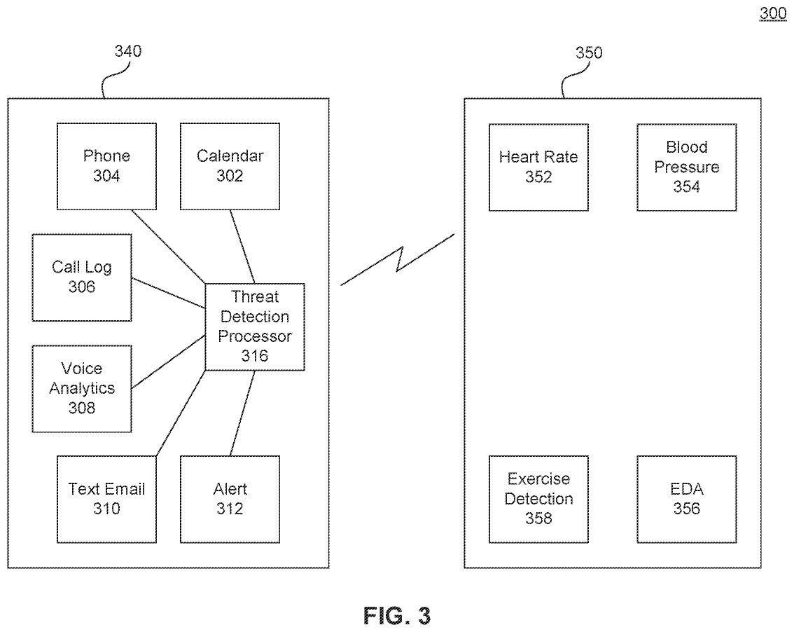

FIG. 3 illustrates a functional block diagram of another exemplary identity theft prevention system 300 according to various embodiments. As shown in FIG. 3, the system 300 includes smart device 340 that may represent an embodiment of smart device 210 of FIG. 2, and wearable device 350 that may represent an embodiment of wearable device 250 of FIG. 2. In the embodiment of FIG. 3, the wearable device 350 includes capabilities for detecting heart rate 352, blood pressure 354, and electrodermal activity 356. This information is provided to a processor within the wearable device 350 which performs exercise detection 358 on the data to determine whether data indicates that the user is exercising or is is a stressed state. The data and/or the results of the exercise detection 358 is provided to the smart device 340 for further analysis.

Meanwhile, in the embodiment of FIG. 3, the smart device 340 includes calendar 302 and phone 304 functionality, and also includes a call log 306, voice analytics 308, text/email 310, and alert 312. The smart device 340 also includes threat detection processor 316, which may represent an embodiment of processors 216 of FIG. 2. As discussed above, the threat detection processor 316 gathers data from the wearable device, and usage statistics from the smart device 340, including information from the calendar 302, the phone 304, the call logs 306, and/or text/email 310. In embodiments, voice analytics 308 further analyzes the user's speech during phone calls or otherwise in order to provide conversation data to the threat detection processors 316. The threat detection processor 316 analyzes the received data in the manner described above and determines whether there is an identity theft threat. Depending on the results of the analysis, alert 312 notifies the user of the potential attack through the use of messages, noises, vibration, or other feedback. In some embodiments, the alert 312 may be linked with the user's account and can take significant preventative action, such as freezing the user's account, flagging the user's account with increased risk, triggering a credit monitoring or credit freeze, etc.

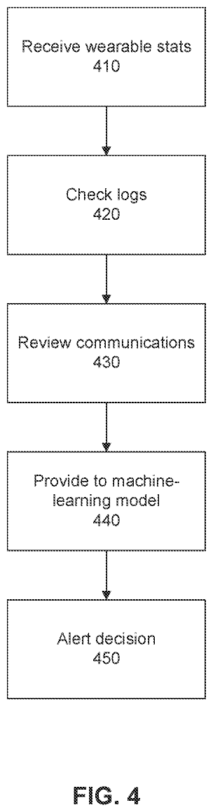

FIG. 4 illustrates a flowchart diagram of an exemplary method 400 for preventing identity theft according to various embodiments. In this embodiment, data is analyzed in an ongoing manner without any particular trigger. As illustrated in FIG. 4, the method begins by the smart device receiving statistics from the wearable device in step 410. Logs, such as calendar entries, call logs, etc, are reviewed in step 420. In step 430, the content of communications are reviewed. As discussed above, this can be done by text-converting spoken conversations and performing keyword/keyphrase searches of text-based communications. In some embodiments, the text conversion may be performed by an automated speech recognition application and/or a natural language processing application.

In step 440, the data is provided to a machine learning model configured to analyze the collected data and determine whether the user is experiencing an identity theft attack. As a result of this analysis, when it is determined that the user is experiencing an identity theft attack, an alert decision is made in step 450 regarding whether such an attack is ongoing, and therefore, whether to alert the user of the likely attack.

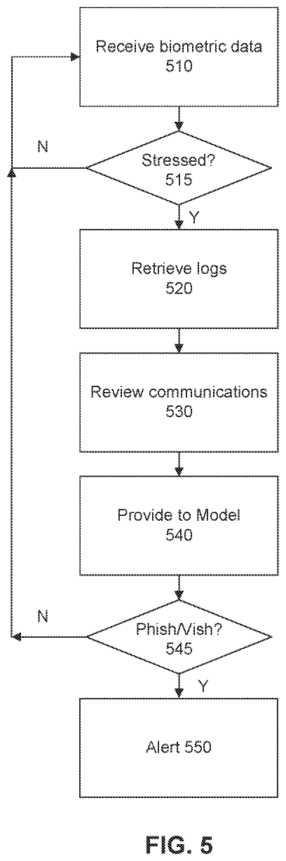

FIG. 5 illustrates a flowchart diagram of an exemplary method 500 for preventing identity theft according to various embodiments. In the example of FIG. 5, the user's stress level is used as a trigger for instigating review of a potential threat. Specifically, as shown in FIG. 5, the method begins by receiving biometric/physiological data from the wearable device in step 510. Based on the biometric/physiological data, the smart device determines whether the user is in a stressed state in step 515. In some embodiments, the stress determination is made by the wearable device, which merely forwards the result to the smart device.

If the user is not in a stressed state (515-N), then the method returns to step 510 to review newly-received biometric data. Alternatively, if the user is determined to be in a stressed state (515-Y), then the method proceeds to step 520, where the smart device initiates the attack detection process and retrieves logs relating to device usage, such as calendar appointments, phone calls, etc. Additionally, the smart device may review communications to or from the user in step 530. As discussed above, this can be performed by the smart device performing speech recognition of voice communications and/or by performing keyword/keyphrase searches of text communications.

Once all the necessary data has been gathered, it is provided to a machine learning model in step 540, which analyzes the information and makes a determination as to whether an identity theft attack is being committed in step 545. If the algorithm determines that an attack is not taking place (545-N), then the method returns to step 510 for new biometric analysis. If however, the algorithm determines that an attack is underway (545-Y), then the user is alerted in step 550.

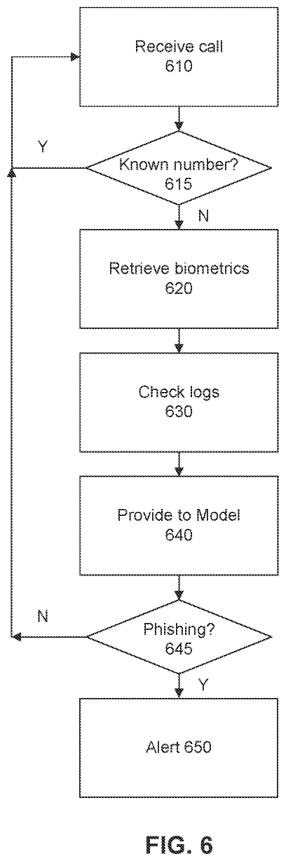

FIG. 6 illustrates a flowchart diagram of an exemplary method 600 for preventing identity theft according to various embodiments. In the example of FIG. 6, an event triggers a deeper analysis of the user's state and situation to determine whether an attack is occurring. In the example of FIG. 6, this event is the receiving of a call from a an unknown number. Specifically, as shown in FIG. 6, the user receives a call in step 610. In step 615, the smart device determines whether the received call is from a known number. If it is (615-Y), then the method returns to step 610. However, if the call is from an unknown number (615-N), the the smart device acquires biometrics from the wearable device in step 620. The smart device can also check usage logs, such as the user's calendar, call logs, etc. in step 630, and provides this information to a machine learning model in step 640.

The model analyzes the data and determines whether a theft identity attack is underway in step 645. If the model determines that no attack is occurring (645-N), then the method returns to step 610. If, however, the model determines that an attack is underway (645-Y), then the smart device alerts the user in step 650.

Although the above example utilizes the receipt of a phone call from an unknown caller as a triggering mechanism, other triggers are also contemplated. For example, the trigger could be the receipt of a text message from an unknown contact, an email from an unknown contact, clicking on a link in a text message or email, access of an untrustworthy site, etc.

In embodiments, the model may be trained based on user feedback. For example, the model may include mechanisms to allow the user to provide inputs that confirm or deny decisions by the model. The model can use these responses to adjust itself for future decision-making. Other inputs to the model may also be used for training, such as an uplink to a central server that provides updated training data. In embodiments, the model outputs a flag when a potential attack is detected that causes the alert to be generated. In embodiments, this flag can be associated with a confidence level indicative of the likelihood or surety that an attack is occurring. In some embodiments, the output is the confidence level alone, which generates or does not generate the attack flag when compared to a predetermined threshold.

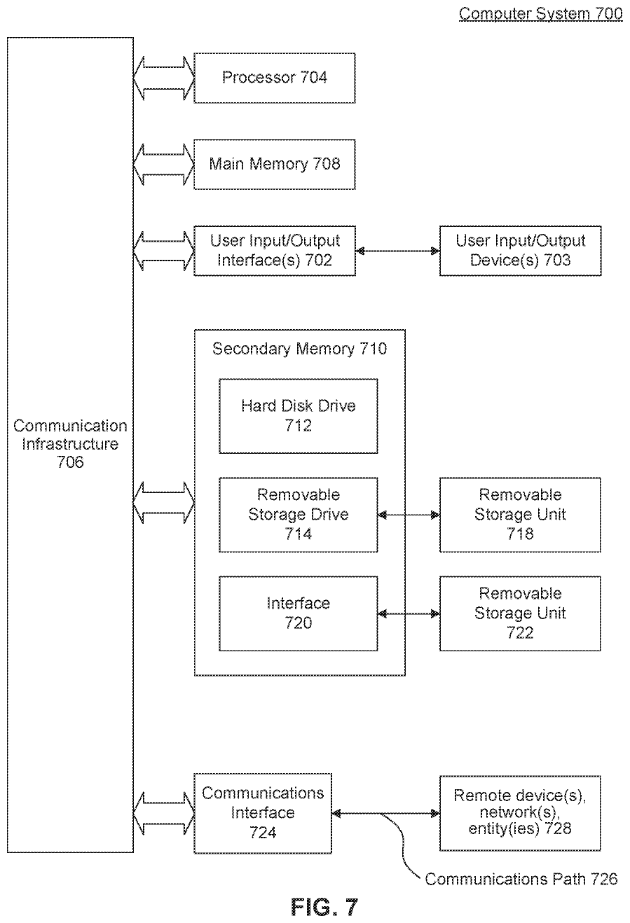

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for preventing an identity theft attempt using a smart device, comprising:
receiving biometric information relating to a user, the biometric information indicating one or more physiological conditions of the user;
retrieving usage information of the smart device, the usage information indicating one or more activities of the user;
analyzing the usage information and the biometric information, the analysis including identifying from the biometric information one or more stress indicators and comparing those stress indicators to the one or more activities of the user;
identifying the identity theft attempt based on the analyzing; and
alerting the user of the identity theft attempt in response to the identifying.

2. The method of claim 1, wherein the biometric information is received from a wearable device.

3. The method of claim 2, wherein the biometric information includes at least one of heartrate, blood pressure, or electrodermal activity.

4. The method of claim 1, wherein the usage information includes calendar information and a call log.

5. The method of claim 4, wherein the analyzing includes comparing a telephone number included in the call log to telephone numbers included in a contact list associated with the smart device.

6. The method of claim 1, wherein the analyzing includes providing the usage information and the biometric information to a machine-learning algorithm.

7. The method of claim 1, wherein the alerting includes at least one of transmitting a text message to the user of the smart device or causing an alert to be displayed on the smart device.

8. A wireless communication device, comprising:
a transceiver configured to communicate with an external device;
a memory that stores usage logs of the wireless communication device; and
one or more processors configured to:
receive information indicating receipt of a communication from an unknown entity;
receive, via the transceiver, biometric data from the external device that indicates one or more physiological conditions of a user;
retrieve the usage logs stored in the memory that indicate usage of the wireless communication device including one or more activities of the user;
analyze the biometric data and the usage logs, the analysis including identifying from the biometric information one or more stress indicators and comparing the stress indicators to the one or more activities of the user;
determine, based on the analyzing, that the user is experiencing an identity theft attempt; and
alert the user of the identity theft attempt in response to the determining.

9. The wireless communication device of claim 8, wherein the information indicating receipt of a communication from an unknown entity includes a phone number or email address.

10. The wireless communication device of claim 9, wherein the analyzing includes comparing the received phone number or email address to an address book of known contacts of the user.

11. The wireless communication device of claim 8, wherein the external device is a wearable device.

12. The wireless communication device of claim 11, wherein the wearable device is one of a fitness tracker or smart watch.

13. The wireless communication device of claim 8, wherein the usage logs include at least one of a user calendar or a call log.

14. The wireless communication device of claim 8, wherein the biometric data includes at least one of a heart rate, blood pressure, or electrodermal activity.

15. A method for preventing identity theft by a wireless communication device, comprising:
receiving a stress indicator from an external device;
determining, based on the stress indicator, that a user of the device is in a stressed state;
in response to the determining:
retrieving usage logs associated with a usage of the wireless communication device, the usage logs indicating one or more activities or actions of the user;
analyzing the usage logs and the stress indicator, the analyzing including comparing the stress indicator to the one or more activities or actions;
identifying, based on the analyzing, an identity theft attempt; and
alerting a user of the wireless communication device of the identity theft attempt in response to the identifying.

16. The method of claim 15, wherein the stress indicator includes biometric data.

17. The method of claim 16, wherein the biometric data includes at least one of heart rate, blood pressure, or electrodermal activity.

18. The method of claim 15, wherein the stress indicator is an indicator that the user is in a stressed state.

19. The method of claim 15, wherein the usage logs include at least one of a calendar and a call log.

20. The method of claim 15, wherein the analyzing includes providing the usage logs and the biometric data to a machine learning algorithm.
